(19) United States
(12) Patent Application Publication
(10) Pub. No.: US 2007/0127323 A1
(43) Pub. Date: Jun. 7, 2007

(54) Network attached mountable optical disc storage library

(76) Inventor: John C. Owens, Arvada, CO (US)

Correspondence Address: PATTON BOGGS, L.L.P., 2001 ROSS AVENUE, SUITE 3000, DALLAS, TX, 75201, US

(21) Appl. No.: 11/607,490

(22) Filed: Dec. 1, 2006

Related U.S. Application Data
(60) Provisional application No. 60/741,745, filed on Dec. 2, 2005.

(51) Int. Cl. G11B 7/085

(52) U.S. Cl. 369/30.38

(57) ABSTRACT

The present network attached mountable optical disc storage library provides a plurality of disc media drives and at least one removable disc storage magazine. A picker traveling on a picker track transports the discs between the disc storage cartridges that are located in the disc storage magazines and the disc media drives. The disc media drives and the disc storage cartridges are coplanar and horizontally located around the picker track such that as the picker travels along the picker track, the disc media drives and the disc storage cartridges are aligned with the picker. The disc storage magazines are located one on each side of the picker track and the disc media drives are radially arranged around the end of the picker track so the picker executes a rotational movement when it reaches the end of the picker track to access the disc media drives.

### FIELD OF THE INVENTION

This invention relates to network attached removable media data storage systems and in particular to an optical disc based data storage library.

### Problem

It is a problem in the field of network attached data storage systems to increase the data storage density of the system while decreasing the equipment storage area required for the media storage and handling mechanisms. Existing network attached data storage systems are traditionally magnetic tape based.

Magnetic tape cartridge autoloaders, also referred to as libraries, are widely accepted because they combine multiple magnetic tape cartridges and a tape drive within a single chassis for higher data storage capacity. Typically, prior art tape cartridge autoloaders have an array of storage positions for tape cartridges, one or more tape drives, and some type of automated changer or cartridge transport for picking or gripping a tape cartridge and moving the tape cartridge between a storage position and the tape drive. The robotic mechanism, often called a “picker” or “gripper”, is typically mounted to the autoloader chassis relative to the tape drive in order to move the tape cartridges between a storage position and the tape drive.

A problem occurs when decreasing the height of the tape cartridge autoloader since operation requires one or more motor mechanisms for moving the tape drive read/write head to read from and write to each of the multiple magnetic tape cartridges. Likewise, one or more motor mechanisms are required to transport the tape cartridges to and from the tape drive. Another problem occurs when increasing the number of magnetic tape cartridges available within the tape cartridge autoloader without increasing the height and the complexity of the tape cartridge autoloader.

The basic architectures of the magnetic tape cartridge autoloaders are limited in number and these architectures are pertinent regardless of the media used to store the data. Therefore, a brief review of existing autoloader architectures is presented to note the physical limitations inherent in many of the commercially available systems.

Vertically Orientated Tape Cartridge Autoloaders

Heinze et al, (U.S. Pat. No. 6,038,099) discloses a tape cartridge autoloader that includes a drive plate for positioning the tape drive. In Heinze, the tape cartridges are horizontally stacked one above the other in a removable magazine and the read/write head is transported up and down to read/write data from/to the tape media enclosed within the tape cartridges. While the tape cartridge autoloader disclosed in Heinze allows multiple tape cartridges to be accessed by a single read/write head, the height of the tape cartridge autoloader is contingent on the number of tape cartridges housed in the magazine. Increasing the number of tape cartridges increases the height of the tape cartridge autoloader. Additionally, valuable space within the chassis is utilized to move the read/write head up and down for reading from or writing to each of the tape cartridges.

A second type of tape cartridge autoloader accommodates multiple tape cartridges and transports the tape cartridge to the stationary tape drive for reading/writing data from/to the tape media enclosed within the tape cartridge. The tape cartridge autoloader disclosed in Schneider, et al., (U.S. Pat. No. 6,229,666) pivots the tape drive about an axis. The multiple tape cartridges are vertically stacked one above the other in a fan orientation wherein the angle of each one of the multiple tape cartridges corresponds to the angle of the pivoting tape drive. In Schneider, the tape drive pivots into alignment for loading and unloading one of the multiple tape cartridges into the tape drive. Like the tape cartridge autoloader disclosed in Heinze, the height of the tape cartridge autoloader in Schneider is contingent on the number of tape cartridges vertically stacked within the magazine. As the magazine is expanded to hold a greater number of tape cartridges, the height of the tape cartridge autoloader is increased.

While the tape cartridge autoloaders just described provide an apparatus for reading from and writing to multiple tape cartridges, they fail to provide a tape cartridge autoloader having a reduced height.

Horizontally Orientated Tape Cartridge Autoloaders

A solution to the increased height of the tape cartridge autoloaders having vertically stacked tape cartridges has been to horizontally stack the tape cartridges. Ostwald (U.S. Pat. No. 5,995,320) discloses a tape cartridge autoloader that orients the tape cartridges in a horizontally oriented loading bin, or magazine. The horizontally oriented storage bin stores tape cartridges like books in a bookcase, each tape cartridge standing next to the adjacent tape cartridge. Unlike the vertically oriented tape cartridge autoloaders previously discussed, the Ostwald tape cartridge autoloader occupies a vertical space consistent with the width of the associated tape cartridges. The horizontal orientation enables the horizontally oriented tape cartridge autoloaders to be mounted in a vertical rack, thus increasing the storage capacity without increasing the vertical height.

However, a problem occurs with the horizontally oriented storage bin. While the tape cartridges are each one-half inch in height, storing the tape cartridges side-by-side increase the vertical height of the tape cartridge autoloader to the width of the tape cartridge. While this tape cartridge storage configuration increases the number of tape cartridges that may be stored in a particular vertical height, the vertical height does not conform to the standard form factor.

The use of vertical racks has become popular to reduce the space required for computer equipment servers, data storage devices, and other computer peripheral equipment. The form factor of vertical racks has been standardized to accept an equipment chassis that is approximately 19 inches wide by 28 inches deep. The “form factor” refers generally to the peripheral dimensions of the chassis. The height of the chassis is in multiples of 1.75 inches, referred to in the industry as a “U”. A 1U height chassis refers to a 1.75 inch height chassis while a 2U height refers to a 3.5 inch height and so on. Peripherals and tape cartridges, such as single reel tape drives and single reel magnetic tape cartridges, also have standardized form factors. For example a single reel tape drive may have a half-high form factor. When referring to the form factor of a tape drive peripheral, the single reel tape drive is a half-high (1.5 inch high) form factor. Thus, the height of the tape drive influences the form factor of the chassis for the tape cartridge autoloaders. Installing a half-high form factor tape cartridge into a tape cartridge autoloader leaves 0.25 inch for operational components. 2U rack-mount tape cartridge autoloaders that accept one-inch tape cartridges are known. The know 2U tape cartridge autoloader is the 640 Blade™ tape cartridge autoloader of Benchmark Storage Solutions. The Benchmark 640 Blade comprises up to up to eight horizontal tape cartridges cells that are rotated in a circular motion around a centrally located tape drive. The tape drive is approximately 1.5 inches in height. In the 640 Blade, fans, motors and other structural features are located below the tape drive, thus the combination of the tape drive and components located below the tape drive influence the overall height of the tape cartridge autoloader.

### SUMMARY

The tape cartridge autoloaders discussed above fail to provide a tape cartridge autoloader that fits within a 1U form factor. Instead, the tape cartridge autoloaders either stack the tape cartridges such that the stack of tape cartridges influences the height of the tape cartridge autoloader or place the operational components below the tape drive, increasing the height of the tape cartridge autoloader. These limitations are directly imported into autoloaders that use disc media as the data storage media and therefore the above noted problems are applicable to the problem of architecting a disc media based autoloader.

### Solution

The present network attached mountable optical disc storage library provides a plurality of disc media drives and at least one removable disc storage magazine. A picker traveling on a picker track transports the discs between the disc storage cartridges that are located in the disc storage magazines and the disc media drives. The disc media drives and the disc storage cartridges are coplanar and horizontally located around the picker track such that as the picker travels along the picker track, the disc media drives and the disc storage cartridges are aligned with the picker. The disc storage magazines are located one on each side of the picker track and the disc media drives are radially arranged around the end of the picker track so the picker executes a rotational movement when it reaches the end of the picker track to access the disc media drives.

A media loading door is located on the front of the network attached mountable optical disc storage library and it allows the user to insert and extract disc storage cartridges from the network attached mountable optical disc storage library. The magazine is moved partially through the media loading door to enable the user to insert/extract disc storage cartridges in the magazine.

Customers benefit from reduced costs, increased reliability, and greater ease of use with these optical drives in automation solutions. The product allows the coexistence of conventional red laser 120 mm DVD technology with the latest blue laser 120 mm optical drives and media in the same library system.

### BRIEF DESCRIPTION OF THE DRAWINGS

FIGS. 1A-1C illustrate perspective, top and front views, respectively, of the present network attached mountable optical disc storage library;

FIG. 2 illustrates the disc storage magazine in the extended position to enable a user to load/unload disc media from the disc storage magazine;

FIG. 3 illustrates a perspective view of the disc storage magazine;

FIG. 4 illustrates a perspective view of an embodiment of the present removable optical disc storage cartridge depicting a two-piece security front door opened and an extractor and optical disc in an extended position;

FIG. 5 illustrates a side plan view of another embodiment of the present removable optical disc storage cartridge depicting a one-piece security front door opened and an extractor and optical disc in an extended position;

FIG. 6 illustrates a top plan view of the present removable optical disc storage cartridge of the embodiment shown in FIG. 5;

FIG. 7 illustrates a top plan view of the present removable optical disc storage cartridge of FIG. 4 depicting an inner side wall and an outer side wall;

FIG. 8 illustrates a cross-section view of the present removable optical disc storage cartridge of FIG. 7 through lines 5-5 depicting the spacing of the extractors;

FIG. 9 illustrates a perspective view of the present removable optical disc storage cartridge of FIG. 4; and

FIG. 10 illustrates a perspective view of the present removable optical disc storage cartridge of FIG. 4 depicting the two-piece security door in a closed position.

### DETAILED DESCRIPTION OF THE DRAWINGS

Brief History of Optical Technology

In 1982 Sony and Philips first introduced the red laser 120 mm CD audio disc. The 120 mm form factor is the most commercially successful of the laser-based optical technology products. Driven by record high volumes in the consumer segment, 120 mm has produced the greatest decrease in cost, the highest increase in aerial density, and the most significant investment of any digital recording technology. In fact, the CD has virtually eliminated the audiotape cassette. Some examples of this are CD-RW, CD-ROM, and CD-R. Due to their low cost, these initial products were soon adapted for data but were limited in their acceptance for data storage because of their capacity of only 650 MB.

In 1996, products using this 120 mm technology were first automated in jukeboxes (libraries), resulting from the need to organize CD-ROM software programs and CD-based data information.

In early 1999 the technology advanced significantly. The advent of the red laser 120 mm DVD technology vaulted the acceptance of 120 mm even further, making. DVD ideal for data storage and automation, with capacities of nearly 5 GB per disc side and transfer rates of 4 MB/sec. This paradigm shift in capacity enabled DVD to challenge 5.25-inch Magneto Optical (MO) products as well as mid-range tape.

Available December 2003, the 120 mm technology once again advanced significantly with the announcement from the Blu-ray consortium blue laser based products. Derived from work done by the Blu-ray consortium of 11 large companies such as Sony, Matsushita, Hitachi, Sharp, Samsung, and Phillips for consumer use, this technology advancement now offers 50 GB of capacity per disc side with transfer rates of 11 MB/sec and costs soon comparable to DVD discs. Blue laser systems are able to store more data than red laser systems because of the shorter wavelength of blue light. This means the laser, which is used to record data on the disc, makes a smaller spot on the recording layer, and that in turn means that the space needed for each bit of data is smaller. Thus more data can be placed onto the disk.

Blue Laser Optical Storage

Since their inceptions, 120 mm CD's and DVD's have both relied on red lasers to ‘bum’ music, video and data onto a disc. Recently, several optical drive manufactures have released breakthrough products utilizing blue lasers which bum a much smaller pit on the surface of each disc, thereby increasing its capacity by a factor of five. A driving force behind the blue laser technology is to replace VHS tape and place a very large HDTV movie on a single side of a DVD. Today, this HDTV movie requires approximately 18 GB of storage capacity, which is unavailable with red laser technology. Another use of the blue laser technology is to replace high-end, commercial, magneto optical (MO). One of the largest benefits of consumer technologies is their ability to provide significant cost reductions throughout their product life cycles.

Optical Data Storage Systems

Optical disc, in the form of DVD media, provides a reliable, cost effective replacement for tape. With DVD having a much faster access time to data than tape, and now having acceptable capacities and transfer rates, this new consumer based optical technology provides new opportunities in the data storage industry.

DVD data storage has traditionally focused on reduced costs for storing large amounts of data. New laws and regulatory compliance now influence the decision for these optical storage solutions. Optical media offers the only truly unalterable Write Once Read Many (WORM) data storage medium, one that will truly hold up in a court of law. WORM media, such as CD-R, DVD-R, and now Blu-ray Disc for the Information Technology sector (BD I/T) as we migrate to High Definition DVD (HD DVD), all play an important role in retaining data for long periods of time in an unalterable, inerasable state, unlike magnetic tape. Magnetic tape can be altered (degaussed) with the simple passing of a strong magnet near the media, thereby destroying the data. Markets such as medical imaging, document imaging, and email archiving are driving the optical storage markets today, and they all require WORM technologies. It is also noteworthy that this technology offers a rewritable medium as well for users who need to rewrite to a disc. This rewritable solution uses the same proven Phase Change Recording principle as CD and DVD have used for years. Traditional DVD markets like the Entertainment and Broadcast market are dominated by DVD technologies.

Magnetic tape cartridge autoloaders, also referred to as libraries, are widely accepted because they combine multiple magnetic tape cartridges and a tape drive within a chassis for higher data storage capacity. With the significant growth in disk capacity on even entry level servers used in a Local Area Network and with the increasing amount of mission critical data being stored on these servers, there is a growing need for tape cartridge automation in the low-end server environment. Organizations seek autoloader solutions that can address the need for a full week's backup of server data, requiring five or more tape cartridges. A one-drive autoloader meets the majority of the needs in this environment.

System Architecture

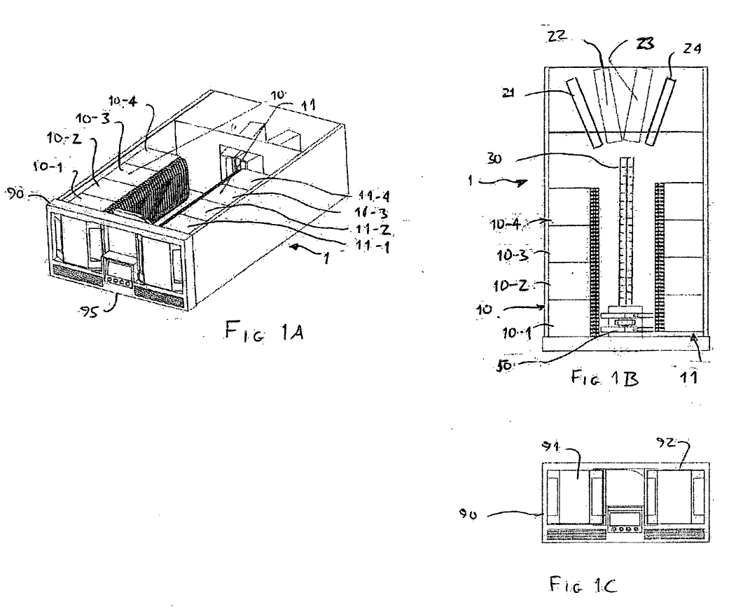

FIGS. 1A-1C illustrate perspective, top and front views, respectively of the present network attached mountable optical disc storage library. Referring to FIGS. 1A-1C, the present network attached mountable optical disc storage library 1 comprises a plurality of disc drives 21-24 and disc storage magazines 10-11 for holding a plurality of disc storage cartridges (10-1 to 10-4 and 11-1 to 11-4) each of which stores up to ten disc media 40-49, all located within a form factor of height +120 mm (4U) and an industry standard rack mount width of 19 inches. The term disc media (or disc) is used herein to denote optically based media, such as the DVDs mentioned above, for the storage and retrieval of data thereon.

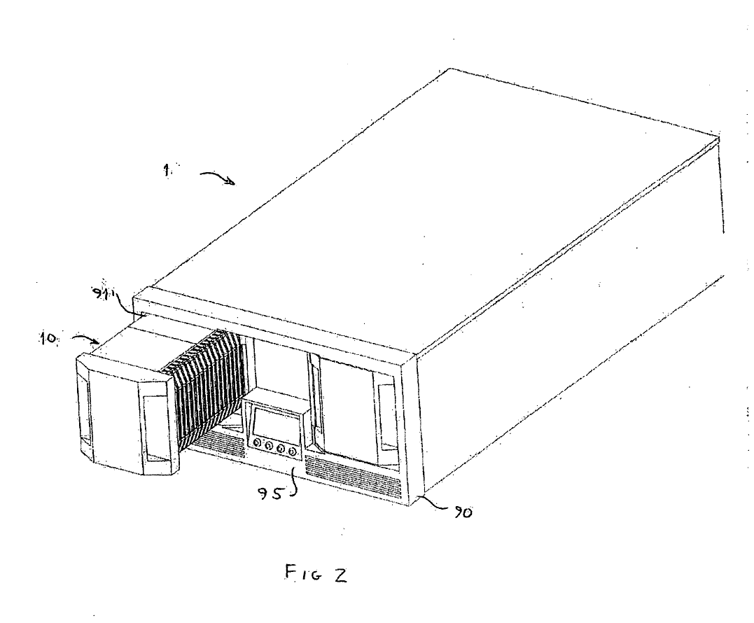

A picker 50 is used to transport discs from the disc cartridges in the disc storage magazines 10-11 to the disc drives 21-24 and the picker 50 travels on a picker track 30 located in the center of the network attached mountable optical disc storage library 1 with one of the disc storage magazines 10-11 being located on each side of the picker track 30. The disc drives are located between the disc storage magazines 10-11 at the rear of the network attached mountable optical disc storage library 1 and are radially arranged around the distal end of the picker track 30. The opening of each disc drive 21-24 faces the picker track 30 for enabling the picker to insert and extract the disc with only a rotational movement once the picker reaches the distal end of the picker track 30. The disc storage magazines 10-11 may function as a drawer that slides in and out of the network attached mountable optical disc storage library 1 for loading and unloading, one at a time, the discs from their associated disc storage cartridge. A corresponding opening 91, 92 in the front panel 90 of the network attached mountable optical disc storage library 1 provides the access required for sliding the disc storage magazine 10-11 into and out of the network attached mountable optical disc storage library 1 as shown in FIG. 2. The front panel may include apparatus for securing the disc storage magazine 10, 11 when the disc storage magazine 10, 11 is retracted into the network attached mountable optical disc storage library 1.

The picker can be implemented in a number of ways, and the present picker 150 includes a transport cell for holding the predetermined one of the plurality of discs as the predetermined one of the plurality of discs is transported between one of the plurality of disc storage cartridges and the disc media drive. The picker 50 also includes a mechanism for inserting/extracting the predetermined one of the plurality of discs into/out of the transport cell by retrieving the optical disc media from a disc storage cartridge that houses the optical disc media. In operation, a positioning system is used to align the picker 50 at a predetermined one of the plurality of respective spaced disc storage cartridges and the disc media drive. This positioning mechanism includes a sensing device connected to the picker 50 and a plurality of disc locators, each one of the plurality of disc locators being connected to one of the plurality of respective spaced positions and the disc media drive, wherein the sensing device engages with the locator to locate each one of the plurality of respective spaced positions and the disc media drive. The picker 50 also has a rotation feature to allow the flipping of a single disc so that both sides can be accessed by the drive without the need to orient drives in special ways. The picker 50 also can be scaled with more than one pick cell to pick more than one disc at the cartridge pick position and then move to insert these multiple discs into multiple drives 21-24 without the need to go back and forth between drives and cartridges.

Library with Magazine Extended

FIG. 2 illustrates the disc storage magazine 10 in the extended position where a portion of the disc storage magazine 10 protrudes from the front panel 90 to enable a user to load/unload disc media from the disc storage cartridges in the disc storage magazine 10. A control panel 95 is provided to implement a user interface for regulating the operation of the network attached mountable optical disc storage library 1. The front panel 90 is provisioned with two openings 91, 92 to enable the insertion and removal of corresponding disc storage magazines into the network attached mountable optical disc storage library 1.

Disc Storage Magazine

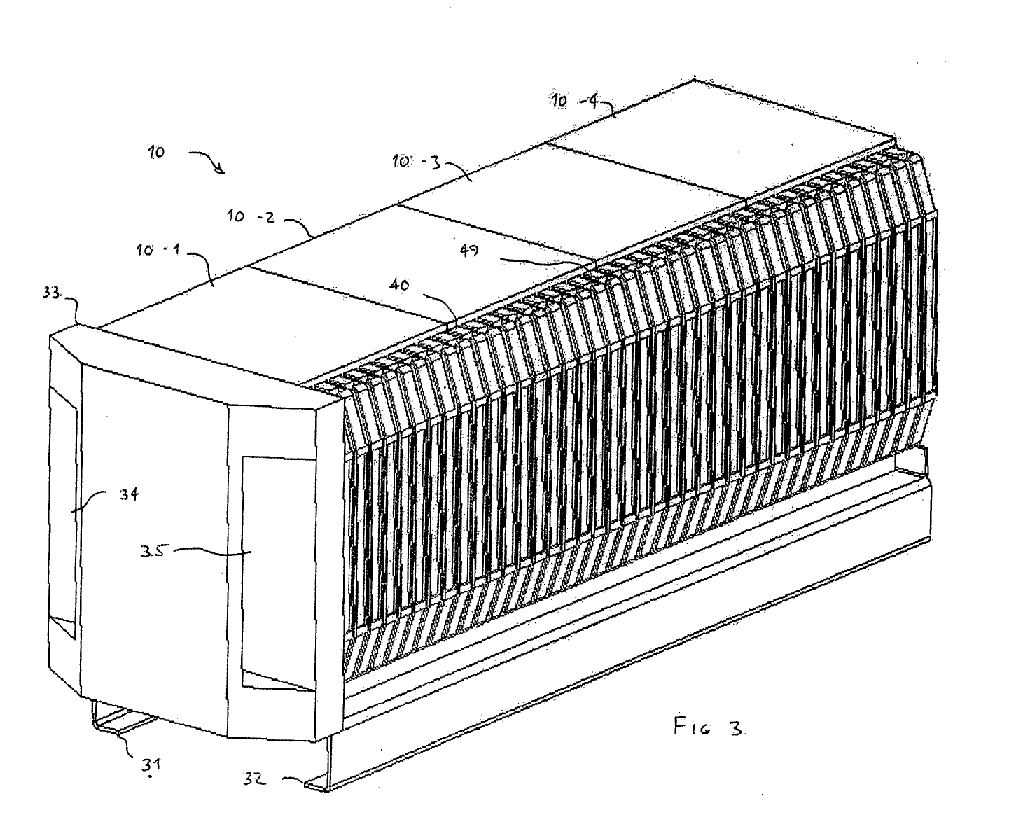

FIG. 3 illustrates a perspective view of the disc storage magazine 10 equipped with a plurality of disc storage cartridges 10-1 to 10-4, each of which houses a plurality of discs. The covers of the disc storage cartridges are shown removed to illustrate the plurality of discs (for example ten discs) stored in each disc storage cartridge 10-1 to 10-4. The disc storage magazine 10 includes an end plate that is equipped with a gripping feature to enable the user to grab the end of the disc storage magazine 10 for extraction from or insertion into the network attached mountable optical disc storage library 1. In addition, the disc storage magazine 10 is provisioned with guides on the bottom thereof for mating with corresponding guide features in the network attached mountable optical disc storage library 1 to align the disc storage magazine 10 with a predetermined precisely defined travel path within the network attached mountable optical disc storage library 1 to ensure alignment of the discs within the data storage cartridges carried by the disc storage magazine with the picker 50. The disc storage magazine 10 includes locking features (not shown) to prevent the unwanted movement or the inadvertent removal of the disc storage magazine 10 once inserted into the network attached mountable optical disc storage library 1.

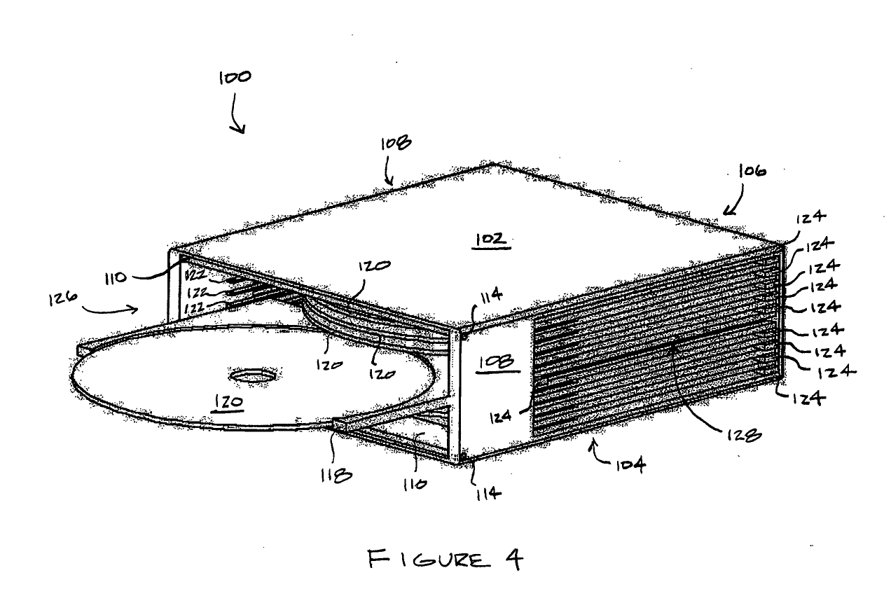

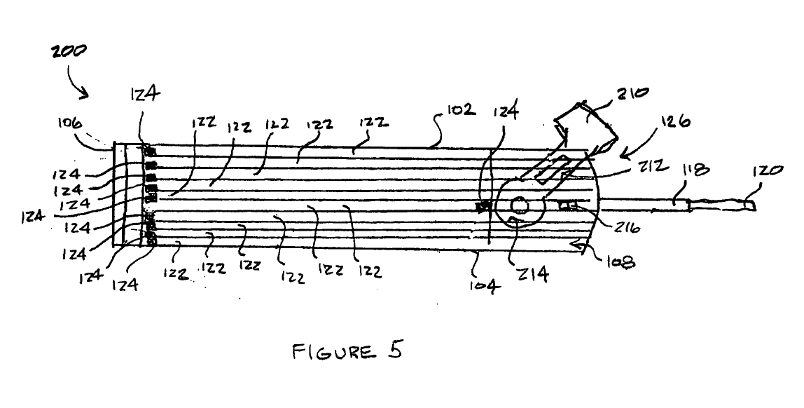

Removable magazines 10, 11 may be used to store several removable optical disc storage cartridges 100 and 200 (as shown in FIGS. 4 and 5) at one time in either a horizontal or vertical orientation. Removable magazines 10, 11 for the removable optical disc storage cartridges 100 and 200 are used to cut down on the time required to load and unload the removable optical disc storage cartridges 100 and 200 from the network attached mountable optical disc storage library 1. Typically, the removable optical disc storage cartridges 100 and 200 are loaded onto a removable magazine 10, 11 and then it is loaded through a media door 91, 92 on the network attached mountable optical disc storage library 1. A picker 50 located within the network attached mountable optical disc storage library 1 then picks a particular optical disc or discs 120 from a removable optical disc storage cartridges 100 and 200 located on the removable magazine 10, 11 or it picks an entire removable optical disc storage cartridge 100 to be presented to a disc drive 21-24. Once a removable magazine 10, 11 is removed from the network attached mountable optical disc storage library 1, the removable optical disc storage cartridges 100 and 200 can be removed from the removable magazine 10, 11 it can be stored outside of the network attached mountable optical disc storage library 1 for future use. In addition, removable magazines 10, 11 can be stored outside of the network attached mountable optical disc storage library 1 with removable optical disc storage cartridges 100 and 200 in place for future use.

Optical Disc Storage Cartridge

The removable optical disc storage cartridge is capable of storing and transporting mixed media, such as optical discs and magnetic optical (MO) discs. In addition, the removable optical disc storage cartridge may be used with all optical disc formats regardless of the reading and writing technology employed for a particular optical disc. For instance, the removable optical disc storage cartridge may be used with red laser technology optical discs or blue laser technology optical discs, or both. Some common optical discs formats include Ultra Density Optical (UDO), CD, DVD, Advanced Optical Disc (AOD), HD DVD and Professional Disc for Data (PDD), or other optical disc formats commonly used. In addition, the removable optical disc storage cartridge may be used with optical discs that have data on one or both sides of the disc. The removable optical disc storage cartridge may be used with different sized optical discs, such as optical discs having a diameter of 120 mm, 130 mm, or both.

FIG. 4 illustrates a side view of an embodiment 100 of the present removable optical disc storage cartridge. Referring to FIG. 4, in one embodiment, the removable optical disc storage cartridge 100 is generally rectangular in shape and consists of a top 102, bottom 104, back 106, front 126, and sides 108. These elements form a cavity within the removable optical disc storage cartridge 100 where several optical discs 120 are stored. Each optical disc 120 is securely held in place by extractors 118 that slide on tracks 122 within the removable optical disc storage cartridge 100 to move the optical discs 120 to and from a picker 50 for transport to at least one drive unit 21-24 of network attached mountable optical disc storage library 1.

The removable optical disc storage cartridge 100 includes a two-piece security front door 110 located on the front 126 of the removable optical disc storage cartridge 100. The security front door 110 opens to expose the extractors 118 and optical discs 120 and closes to form an airtight seal against the top 102, bottom 104, and sides 108 of the removable optical disc storage cartridge 100. In one embodiment, the removable optical disc storage cartridge 100 includes a hinge 114 for providing rotatable support for the security front door 110. In one embodiment, slots 128 are provided to enable extractor tabs 124 to connect and operate with the extractors 118 to slide the extractors 118 between an extended and retracted position. In FIG. 1 a slot is shown behind the extended extractor 118. Though only one slot 128 is shown in FIG. 1, the others associated with the other extractor tabs 124 and extractors 118 are not shown because they are blocked by their respective retracted extractor 118.

FIG. 5 illustrates a side view of another embodiment 200 of the present removable optical disc storage cartridge, which includes many similarly numbered elements as found in FIG. 4 that correlate to the same description described herein. In addition to those similarly numbered and described elements, removable optical disc storage cartridge 200 includes a one-piece security front door 210, hinge 214, and a security tab slot 212 that engages a security tab 216 for securely locking the one-piece security front door 210 to prevent unauthorized access to the optical discs 120.

In one embodiment, the picker 50 interacts with the security front doors 110 and 210 to operate the security tab slot 212 (not shown in FIG. 4) or the security tab 216 (not shown in FIG. 4), or both. Then the picker 50 further interacts with the security front doors 110 and 210 to open and later close the security front doors 110 and 210. In another embodiment, a mechanical arm separate from the picker 50 operates the tab slot 212, the security tab 216, or the security front doors 110 and 210, or some or all of them.

Extractors

The extractors 118 slide forward and backward between a retracted position and an extended position within the cavity of the removable optical disc storage cartridges 100 and 200. As shown in FIGS. 4 and 5, extractor 118 is in the extended position and is shown beyond the front 126 of the removable optical disc storage cartridges 100 and 200. The extractors 118 are connected to extractor tabs 124 that are accessible externally or internally to the removable optical disc storage cartridges 100 and 200, thus when a particular extractor tab 124 is moved in a forward or backward direction the extractor 118 connected to that particular extractor tab 124 is also moved similarly. In another embodiment, the extractor tabs 124 are accessible to the picker inside of the removable optical disc storage cartridges 100 and 200. The number of extractors 118 contained within the cavity of the removable optical disc storage cartridges 100 and 200 may vary depending on a desired application. In the preferred embodiment, the removable optical disc storage cartridges 100 and 200 contain ten extractors 118 and accordingly ten extractor tabs 124. Moreover, the extractor tabs 118 may be on either or both sides of the removable optical disc storage cartridges 100 and 200.

The arm of the picker 50 hooks or engages the extractor tabs 124 to operate the extractors 118 of the removable optical disc storage cartridges 100 and 200. One or both extractor tabs 124 of any one extractor 118 may be engaged with the arm of the picker 50. The picker 50 then pulls the extractor tab 124 toward the picker 50, thus bringing the optical disc 120 to the fully extended position. Once the desired optical disc 120 is extracted or removed from the removable optical disc storage cartridges 100 and 200, the picker 50 returns the empty extractor and then returns the empty extractor and closes the security front doors 110 and 210.

The dimensions of the removable optical disc storage cartridges 100 and 200 are dependent upon the number of extractors 118 used for a particular design. In one embodiment, the removable optical disc storage cartridges 100 and 200 are designed to be used with retrofitted existing disc drives and disc library systems. For instance, when using ten extractors 118 as shown in FIGS. 4-10, the removable optical disc storage cartridge 100 has the general dimension of 5.0″ W×5.0″ L×1.0″ H.

In an embodiment, the extractors 118 are horseshoe-shaped or substantially U-shaped such that the ends of the extractor extend outward from the front 126 of the removable optical disc storage cartridges 100 and 200 as the optical disc 120 is extracted. In one embodiment, the extractor 118 has a groove that extends generally along the inside perimeter of its shape. This groove provides the support for holding and ejecting an optical disc 120 without scratching the surfaces of the optical disc 120. In this embodiment, the extractor has a width that is slightly less than the distance between the two tracks 122 that contains it. This way the extractor slides in and out between an extended and a retracted position.

Automation Grip Notches

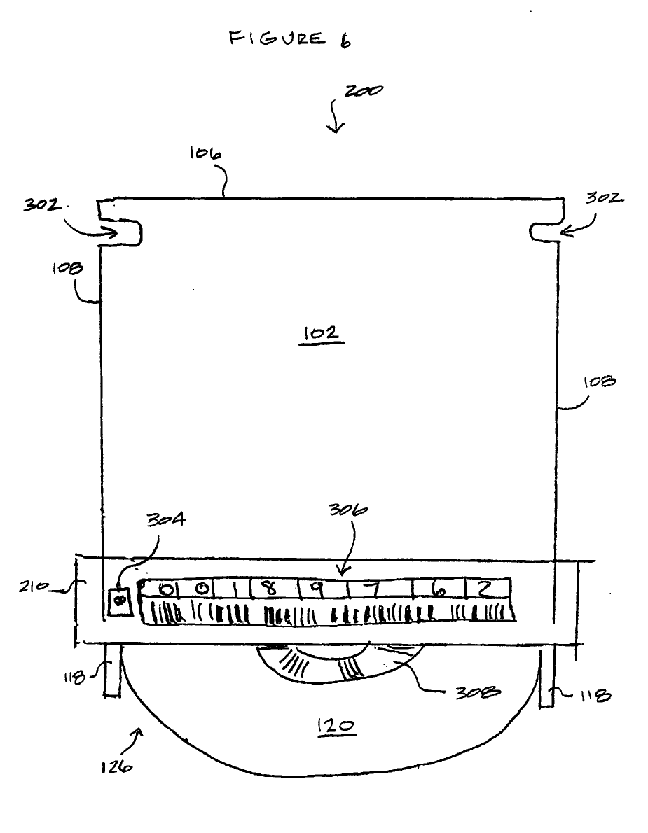

FIG. 6 illustrates a top plan view of the removable optical disc storage cartridge 200, which shows two automation grip notches 302 near the back 106 of removable optical disc storage cartridge 200. Though not shown, removable optical disc storage cartridge 200 may also include these automation grip notches 302. In one embodiment, a picker 50 grips the removable optical disc storage cartridges 100 and 200 by these automation grip notches 302 and transports the entire removable optical disc storage cartridges 100 and 200 to the disc drive 21-24. In this embodiment, the back 106 of the removable optical disc storage cartridges 100 and 200 are oriented to face the picker 50. In another embodiment, the front 126 of the removable optical disc storage cartridges 100 and 200 are oriented to face the picker 50.

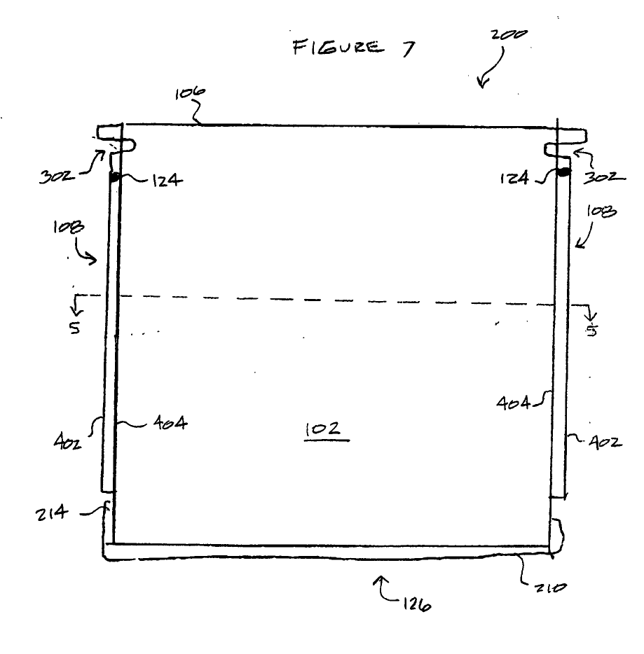

FIG. 7 illustrates a top plan view of the removable optical disc storage cartridge 200 that shows the outer side wall 402 and the inner side wall 404 of a side 108. Removable optical disc storage cartridge 100 preferably includes an outer side wall 402 and inner side wall 404. The outer side wall 402 and inner side wall 404 are structurally such that they keep the cavity of the removable optical disc storage cartridges 100 and 200 contaminant free during storage of the optical discs 120. The inner side wall 404 and outer side wall 402 preferably contain slots 128 (as shown in FIG. 4) for allowing the extractor tabs 124 to connect to the extractors 118 inside the removable optical disc storage cartridges 100 and 200. These slots 128 are blocked by each extractor 118 associated with that particular slot 128.

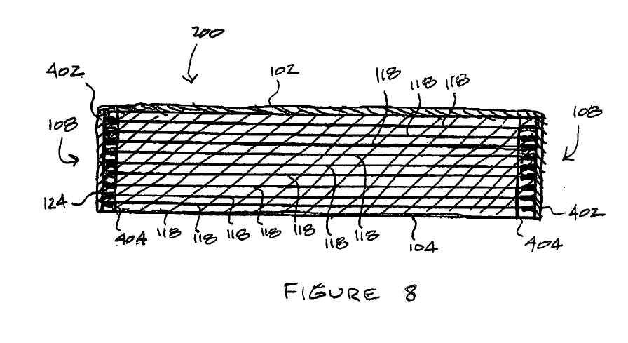

FIG. 8 illustrates a cross-section of the removable optical disc storage cartridge 200 through 5-5 of FIG. 7. The extractors 118 of the removable optical disc storage cartridge 200 are shown spaced apart from each other within the cartridge. In one embodiment, the spacing between the extractors 118 is such that it provides spacing of approximately 0.060 of an inch between the optical discs 120 when they are stored within the removable optical disc storage cartridges 100 and 200. Although FIGS. 4-8 illustrate ten extractors 118, the present removable optical disc storage cartridges 100 and 200 may use any number of extractors 118 as desired. The spacing between the extractors 118 may be any distance such that it provides sufficient clearance between adjoining optical discs 120 without them coming into contact with each other.

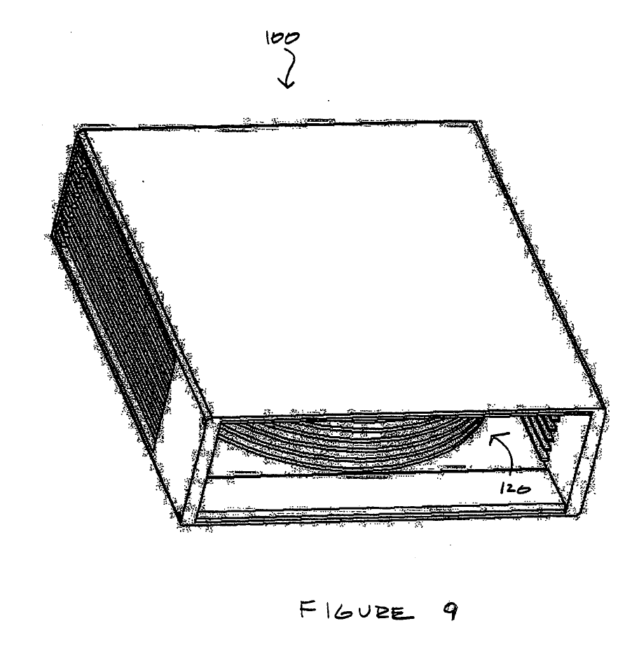

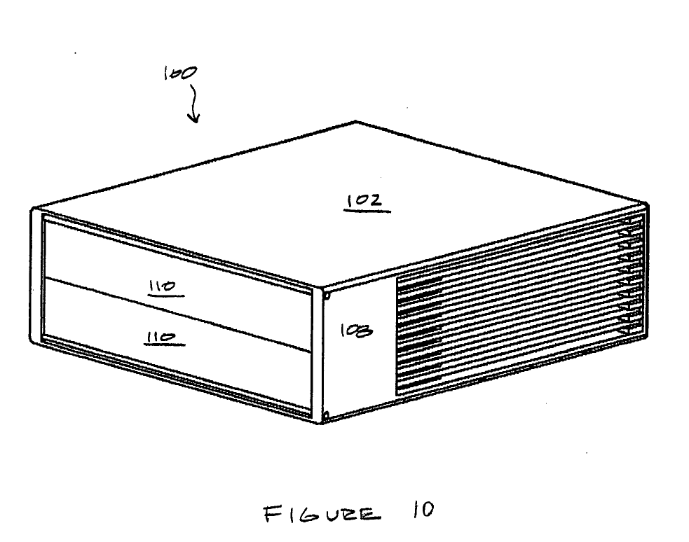

FIG. 9 illustrates a perspective view of removable optical disc storage cartridge 100 with the optical discs 120 in their stored position. In addition, FIG. 10 illustrates a perspective view of removable optical disc storage cartridge 100 with the optical discs 120 in their stored position and the security front doors 110 in a closed position.

Security Front Doors

As discussed above, the security front doors 110 and 210 may be located on the front 126 of the removable optical disc storage cartridges 100 and 200. In one embodiment, the security front door 210 is comprised of a single piece of material and opens and closes via hinge 214. In another embodiment, the security front door 110 may be comprised of multiple pieces and opens and closes via hinge 114. In either embodiment, it is a novel aspect of the present removable optical disc storage cartridges 100 and 200 that the security front doors 110 and 210 create a tight seal between themselves and their adjoining structure as noted above. In one embodiment, this airtight seal is created by ridges formed on the security front doors 110 and 210 and the adjoining the top 102, bottom 104, and sides 108 that interlock, overlap, or mesh together to create a barrier to prevent dirt and dust from entering the removable optical disc storage cartridges 100 and 200. Other mechanical means can be employed, such as rubber seals, Teflon® seals, fabric seals, etc.

As noted above, in one embodiment, the tab slot 112 and tab 116 works together to securely lock the security front door 110 in a locked closed position. In one aspect, the picker 50 operates the tab 116 by exerting a mechanical force on the tab 116 so that it is pushed inward, thus away from the tab slot 112, so that the security front door 110 may be opened. The picker 50 then mechanically opens the security front doors 110 and 210. In a multi-piece embodiment, the pieces may be connected by a mechanical hinge that operates both doors as the picker 50 operates on just one of the doors. In another aspect, the pieces may be operated individually or separately by the picker 50.

In one embodiment, the picker 50 employs one motor that operates a mechanical arm to mechanically operate the tab 116 and the security front doors 110 and 210. In another embodiment, the picker 50 employs multiple motors and mechanical arms to mechanically operate the tab 116 and the security front doors 110 and 210. Other locking means may be employed for securing the front doors 110 and 210 in place of or in addition to the tab 116 and the tab slot 112. These additional locking means may include dowels, grooves, holes, pins, locks, detents, catches, magnetic/electrical closures, etc.

In another embodiment, the security front door 110 may be locked when the removable optical disc storage cartridges 100 and 200 are outside of an optical disc storage library, but unlocked once placed in a removable magazine and inserted into the optical disc storage library. In this embodiment, an unlocking arm that is part of the removable magazine mechanically interacts with the removable optical disc storage cartridges 100 and 200 when they are placed in the removable magazine.

Optical Disc Storage Cartridge Materials

The top 102, bottom 104, sides 108, and security front doors 110 and 210 of the removable optical disc storage cartridges 100 and 200 are typically made by a molding process or assembled from molded or manufactured parts, and it is made from a rigid moldable material. Some exemplary materials include polycarbonate, LDPE, HDPE, copolyester, polystyrene, Acrylonitrile Butadiene Styrene (ABS), polypropylene, and polyethylene, for example. In addition, these materials may be mixed, combined, or impregnated with a different type of material to impart additional rigidity, impact resistance, or lower coefficient of friction, or all three. Some exemplary additional materials include Teflon®, glass, carbon, etc. In a preferred embodiment, the top 102, bottom 104, and sides 108 are made of glass filled polycarbonate.

The tracks 122 may be molded or formed as part of the removable optical disc storage cartridges 100 and 200, or it may be molded separately and then assembled into the removable optical disc storage cartridges 100 and 200. Additionally, it may be made out of the same material as the removable optical disc storage cartridges 100 and 200, noted above. To provide for a greater frictionless surface for the extractors 118 to operate on, the material of the tracks 122 may also be mixed, combined, or impregnated with additional materials such as Teflon®, glass, carbon, etc. In a preferred embodiment, the security front doors 110 and 210 and extractors 118 are made of Teflon® filled polycarbonate. In one embodiment, the tracks 122 are molded or formed into the inner side wall 404 during manufacturing of the removable optical disc storage cartridges 100 and 200. In another embodiment, the tracks 122 are manufactured and then secured to the inner side wall 404 of the removable optical disc storage cartridges 100 and 200. In the preferred embodiment, each track 122 accompanies one extractor 118, and each extractor 118 slides along its designated track 122 for transporting an optical disc 120 to and from the picker 50.

In one embodiment, the extractors 118 and extractor tabs 116 are made by a molding process or assembly of molded or manufactured parts, and it is made from a rigid moldable material. Some exemplary materials include polycarbonate, LDPE, HDPE, copolyester, polystyrene, Acrylonitrile Butadiene Styrene (ABS), polypropylene, and polyethylene, for example. In addition, these materials may be mixed, combined, or impregnated with a different type of material to impart additional rigidity, impact resistance, or lower coefficient of friction, or both. Some exemplary additional materials include Teflon®, glass, carbon, etc. In addition, the materials of the removable optical disc storage cartridges 100 and 200, extractors 118, extractor tabs 116, and tracks 122 may be different materials.

Disc and Disc Storage Cartridge Labeling

The discs housed within a disc storage cartridge are labeled to maintain an association between the discs and their assigned disc storage cartridge.

In one embodiment shown in FIG. 3, the removable optical disc storage cartridges 100 and 200 include radio frequency identification (RFID) chip 304 (not shown in FIG. 4), for reading by a RFID reader, that contains identification information regarding the cartridge and additional information related to the optical discs located within the removable optical disc storage cartridges 100 and 200. In another embodiment, the removable optical disc storage cartridges 100 and 200 include a cartridge ID barcode 306 (not shown in FIG. 4) that contains identification information regarding the cartridge and additional information related to the optical discs 120 located within the removable optical disc storage cartridges 100 and 200. Removable optical disc storage cartridge 100 may also include the RFID chip 304, cartridge ID barcode 306, or both. In yet another embodiment, either or both of the RFID chip 304 and the cartridge ID barcode 306 may be used. Some additional exemplary information that may be contained on the RFID chip 304 or the cartridge ID barcode 306, or both, include information related the presence or absence of a particular cartridge, the type of cartridge, etc.

In an embodiment, any information related to a particular optical disc 120 is contained on the radial media ID barcode 308 that is located on the inner portion of the optical disc 120. In this embodiment, this information is standard barcode that is read by the picker 50 itself as the optical disc 120 is presented to the picker 50. In another embodiment, a reader separate from the picker 50 or connected to the picker 50 reads the radial media ID barcode 308 in a conventional linear manner. In this embodiment, the reader may read the radial media ID barcode 308 in a circular or radial fashion without having to spin the optical disc 120. Some exemplary information that may be contained on the radial media ID barcode 308 include: disc format (red or blue laser), disc capacity, disc manufacturer, etc.

In an embodiment of the network attached mountable optical disc storage library, the arm of the picker 50 that operates the security front doors 110 and 210 includes the RFID reader, barcode reader, or both, for reading the RFID chip 304, cartridge ID barcode 306, or both for inventorying the removable optical disc storage cartridges 100 and 200 contained within a removable magazine and the optical discs 120 contained within a particular removable optical disc storage cartridges 100 and 200. In another embodiment, the picker 50 and the RFID reader, barcode reader, or both, for reading the RFID chip 304, cartridge ID barcode 306, or both are separate parts. An inventory of the existing the removable optical disc storage cartridges 100 and 200 located within an optical disc storage library occurs during the powering up of the optical disc storage library or by new media introduction by the RFID reader or barcode reader. This operation inventories whether a particular cell in a removable magazine contains a removable optical disc storage cartridges 100 and 200.

The information contained on the RFID chip 304 or the cartridge ID barcode 306 preferably contains information regarding those optical discs 120 contained within removable optical disc storage cartridges 100 and 200. In part this information is useful in identifying the removable optical disc storage cartridges 100 and 200 that a particular optical disc 120 should be returned to after power re-initiation following a loss of power. Following the powering up of an optical disc storage library, the picker 50 will determine the identification of an optical disc 120 in its possession by the radial media ID barcode 308 and will be able to return that optical disc 120 to its proper removable optical disc storage cartridges 100 and 200.

Although there has been described what is at present considered to be the preferred embodiments of the present removable optical disc storage cartridge, it will be understood that the removable optical disc storage cartridge can be embodied in other specific forms without departing from the spirit or essential characteristics thereof. For example, various shapes and sizes for the removable optical disc storage cartridge may be used other than those noted. In addition, other cartridge and optical disc identification means, extractor tabs, and extractors may be employed without departing from the spirit or essential characteristics thereof. The scope of the invention is indicated by the appended claims rather than the foregoing description.

Summary

The present network attached mountable optical disc storage library provides at least one media drive and at least one removable disc storage magazine having a plurality of storage cells for storing disc media modules. A picker traveling on a picker track transports the discs between the storage cells and the disc media drive. The disc media drive and the disc storage magazine are horizontally located around the picker track and aligned with the picker.

What is claimed:

1. A mountable optical disc media storage library for managing a plurality of disc storage cartridges and their housed disc media, comprising:
disc media drive means having a disc media aperture for inserting/extracting one of said plurality of disc media therein;
at least one removable disc storage magazine having a first end, a second end, and a plurality of respective spaced positions located between said first end and said second end for storing the plurality of disc storage cartridges, wherein the at least one removable disc storage magazine and the disc media drive means are horizontally positioned in a housing;
picker means for transporting and/or flipping a predetermined one or more of the plurality of discs between one of the plurality of disc storage cartridges in said at least one removable disc storage magazine and said disc media drive means; and
magazine loader means for translating said first end of said at least one removable disc storage magazine outside of said housing to expose a predetermined number of the plurality of disc storage cartridges outside of said housing for inserting/extracting disc storage cartridges.

2. The mountable optical disc media storage library of claim 1 wherein said magazine loader means comprises:
release means for releasing said at least one removable disc storage magazine to enable a user to remove said at least one removable disc storage magazine from said housing.

3. The mountable optical disc media storage library of claim 1 wherein said magazine loader means comprises:
lock means for securing said at least one removable disc storage magazine in said housing to enable said picker means to insert/extract one of said plurality of disc media in said one of the plurality of disc storage cartridges in said at least one removable disc storage magazine.

4. The mountable optical disc media storage library of claim 1 wherein said at least one removable disc storage magazine comprises a plurality of respective spaced positions located between said first end and said second end for storing the plurality of disc storage cartridges.

5. The mountable optical disc media storage library of claim 1 wherein said picker means is capable of receiving at least one optical disc media from said disc storage cartridges.

6. The mountable optical disc media storage library of claim 1 wherein said picker means comprises:
a transport cell for holding the predetermined one of the plurality of discs as the predetermined one of the plurality of discs is transported between one of the plurality of disc storage cartridges and the disc media drive; and
means for inserting/extracting the predetermined one of the plurality of discs into/out of the transport cell.

7. The mountable optical disc media storage library of claim 6 wherein said picker means comprises:
means for retrieving an optical disc media from a disc storage cartridge housing said optical disc media.

8. The mountable optical disc media storage library of claim 1 further comprising:
means for positioning the picker means at a predetermined one of the plurality of respective spaced disc storage cartridges and the disc media drive.

9. The mountable optical disc media storage library of claim 8 wherein the positioning means comprises:
a sensing device connected to the picker means; and
a plurality of locator means, each one of the plurality of locating means connected to one of the plurality of respective spaced positions and the disc media drive, wherein the sensing means engages with the locator means to locate each one of the plurality of respective spaced positions and the disc media drive.

10. A mountable optical disc media storage library for managing a plurality of disc media modules, comprising:
disc media drive means having a disc media aperture for inserting/extracting one of said plurality of discs therein;
two removable disc storage magazines, each having a first end, a second end, and a plurality of respective spaced positions located between said first end and said second end for storing a plurality of disc storage cartridges, each of which houses a plurality of discs, wherein the two removable disc storage magazines and the disc media drive means are located in a housing in a coplanar orientation, with a first of said removable disc storage magazines being located opposite a second of said removable disc storage magazines;
picker means, operable in a space between said two removable disc storage magazines, for transporting a predetermined one of the plurality of discs between one of the plurality of respective spaced positions in said two removable disc storage magazines and said disc media drive means; and
magazine loader means for translating said first end of at least one of said two removable disc storage magazines outside of said housing to expose a predetermined number of the plurality of respective spaced positions outside of said housing for inserting/extracting disc storage cartridges in said at least one of said predetermined number of the plurality of respective spaced positions.

11. The mountable optical disc media storage library of claim 10 wherein said magazine loader means comprises:
release means for releasing said two removable disc storage magazines to enable a user to remove said two removable disc storage magazines from said housing.

12. The mountable optical disc media storage library of claim 10 wherein said magazine loader means comprises:
lock means for securing said two removable disc storage magazines in said housing to enable said picker means to insert/extract one of said plurality of discs in said one of the plurality of respective spaced disc storage cartridges in said two removable disc storage magazines.

13. The mountable optical disc media storage library of claim 10 wherein said two removable disc storage magazines comprises a plurality of respective spaced positions located between said first end and said second end for storing the plurality of disc storage cartridges, wherein the plurality of respective spaced positions are capable of receiving disc storage cartridges.

14. The mountable optical disc media storage library of claim 10 wherein said picker means is capable of receiving optical disc media.

15. The mountable optical disc media storage library of claim 10 wherein said picker means comprises:
a transport cell for holding the predetermined one of the plurality of discs as the predetermined one of the plurality of discs is transported between one of the plurality of disc storage cartridges and the disc media drive; and
means for inserting/extracting the predetermined one of the plurality of discs into/out of the transport cell.

16. The mountable optical disc media storage library of claim 15 wherein said picker means comprises:
means for retrieving an optical disc media from a disc storage cartridge housing said optical disc media.

17. The mountable optical disc media storage library of claim 10 further comprising:
means for positioning the picker means at a predetermined one of the plurality of disc storage cartridges in a one of said two removable disc storage magazines.

18. The mountable optical disc media storage library of claim 17 wherein the positioning means comprises:
a sensing device connected to the picker means; and
a plurality of locator means, each one of the plurality of locating means connected to one of the plurality of respective spaced positions in a both of said two removable disc storage magazines, wherein the sensing means engages with the locator means to locate each one of the plurality of respective spaced positions in said two removable disc storage magazines.
